(19) United States
(12) Patent Application Publication
(10) Pub. No.: US 2012/0302427 A1
(43) Pub. Date: Nov. 29, 2012

(54) POLYMERIC STRUCTURES FOR ADSORBING BIOLOGICAL MATERIAL AND THEIR METHOD OF PREPARATION

(75) Inventors: Noha Elmouelhi, Randolph, NJ (US); Kevin Cooper, Flemington, NJ (US); Sriram Natarajan, Bridgewater, NJ (US); Hong Yee Low, Botannia (SG); Isabel Rodriguez, Singapore (SG); Emma Kim Luong-Van, Singapore (SG)

(73) Assignees: AGENCY FOR SCIENCE TECHNOLOGY AND RESEARCH, Connexis (SG); ADVANCED TECHNOLOGIES & REGENERATIVE MEDICINE, LLC, Raynham, MA (US)

(21) Appl. No.: 13/340,405

(22) Filed: Dec. 29, 2011

Related U.S. Application Data
(63) Continuation-in-part of application No. 13/116,721, filed on May 26, 2011.

(51) Int. Cl. B01J 20/28; B01J 20/30

(52) U.S. Cl. 502/5; 502/402

(57) ABSTRACT

A biologic-adsorbent, e.g., protein-adsorbent, material is prepared by forming a polymeric substrate into structures having high surface area topography whose biologic adsorbing properties can be controlled. Biologic adsorption by these structures of optimized high surface area topography is increased by mild treating of the surfaces, e.g., by oxygen plasma, without substantially altering topography. Structures can have tailored geometric features including microstructures, e.g., pillars, with a diameter from 100 nm-50 μm and height greater than 1 μm.

### RELATED APPLICATIONS

This patent application is a continuation-in-part of U.S. patent application Ser. No. 13/116,721, filed on May 26, 2011, directed to Polymeric Structures for Adsorbing Biological Material and Their Method of Preparation, which is hereby incorporated by reference in its entirety.

### FIELD OF THE INVENTION

The present invention relates to polymer-based structures having shapes and mechanical properties that optimize adsorption of biologics, e.g., proteins.

### BACKGROUND OF THE INVENTION

There is an ongoing need for polymer-based structures having improved adsorption of biologics, e.g., proteins. Such structures can be suited for use in various applications, such as medical applications, e.g., medical diagnostics. It is especially desirable to provide structures whose surfaces have a specific, finely-tuned adsorption of biological materials.

U.S. Pat. No. 5,246,451 discloses a vascular prosthesis made by coating a vascular graft material such as polyethylene terephthalate plasma coated with a fluoropolymer (PTFE) which is then treated with a plasma in a non-polymerizing gas atmosphere, e.g., oxygen, to improve biological entity binding to the fluoropolymer. The products of this disclosure rely on plasma treatment to improve protein binding and lack modified topography.

U.S. Pat. No. 7,195,872 teaches providing substrates of high surface area with structural microfeatures that provide access to fluids and components therein. The substrates can be prepared by molding, embossing, photoresist techniques and can also be treated by etching, e.g., with argon, oxygen, helium, chlorine, SF₆, CF₄, and C₄F₈ gases. Surfaces can be modified by chemical treatments or radiative treatments, e.g., plasma treatment in gases. The reference emphasizes topography alone to bind proteins, or alternately, additional treatment with oxygen plasma to etch the surface and ammonia plasma for grafting amine groups on the surface.

Microelectronic Engineering 86 (2009) 1424-1427 teaches treating substrates of poly(methyl methacrylate) polymer (PMMA) by oxygen plasma treatment to induce roughening, or nano-texturing. The plasma treatment and ageing conditions control topography height and surface chemistry of the substrate. Protein adsorption is taught to increase 2-4 times when the surface undergoes hydrophobic recovery, i.e., loss of hydrophilicity over time.

Microelectronic Engineering 86 (2009) 1321-1324 shows treating substrates of poly(dimethylsiloxane) polymer (PDMS) by plasma-induced SF₆ treatment which removes hydrophobic organic methyl groups and forms columnar-like nanoroughness on the substrate surfaces, i.e., plasma-induced topography. Increased protein adsorption is observed after oxygen plasma treatment and induced hydrophobic recovery.

The art thus describes treating substrates with plasma alone or topography alone to improve protein binding or adsorption. The art discussing the combination of the two is limiting in that it involves surface hydrophobization or surface etching or grafting to increase protein binding or adsorption. Additionally, the art does not discuss ways to modulate the amount of protein adsorption.

Accordingly, it would be desirable to provide wettable polymer-based structures of substantially fixed topography having controllable adsorption of biologics, e.g., proteins, by adjusting characteristics of a substrate to provide a topography of enhanced surface area that is relatable or proportional to the surface adsorption of a biologic material.

### SUMMARY OF THE INVENTION

The present invention relates to structures which have a specific, finely-tuned adsorption of biological materials used in various applications, including medical applications, e.g., medical diagnostics. These structures can be prepared from a substrate by imparting to it a desired topography of increased surface area (relative to that of a flat or substantially planar surface), and treating the increased surface area to improve wettability, without substantially reducing the increased surface area of the substrate. This treatment can optimize adsorption of biologics by making substantially all of the surface area of the substrate accessible to biologics. Such treating can be, e.g., plasma treating under conditions which impart increased wettability without substantially reducing surface area of the substrate.

Thus, the present invention utilizes both topography and wettability to achieve a desired amount of biologics adsorption. Surface topography or structures can be used to increase the surface area available for biologics adsorption. Any surface topography can be employed, with higher surface areas achieved using high aspect ratio structures, closely-spaced structures, and/or hierarchical structures. It is desirable, however, that the surface be wettable to provide access of the biologics to the structures. Thus, topography and wettability together provide the desired enhanced biologics or protein adsorption. Processes to introduce topography include casting and imprinting, e.g., nanoimprinting or hot embossing. Processes enhancing surface wettability include plasma treatment. By the present invention, biologics adsorption onto an appropriate structure of a desired topography can be controlled by applying surface wetting techniques to the structure surface, including the surface of its substructures, e.g., pillars. Bioabsorbable and biodurable polymers, e.g., poly(lactic-co-glycolic acid) (PLGA), poly(dimethyl)siloxane (PDMS), and polypropylene (PP), respectively, are especially suited to use in the invention.

The present invention relates to polymer-containing substrates that include substructures of high surface area, secured to or integral with the structure, which can be further treated to increase wettability and biologic adsorption. For present purposes substructures can include nanostructures or microstructures, defined as substructures having at least one dimension ranging from about 100 nanometers to about 50 microns.

The present invention differs from the prior art insofar as it provides a polymeric substrate of specific topography formed by contact with a shaped or textured form, e.g., molding or casting, imprinting, say, nanoimprinting, or hot embossing, to impart greater surface area. Hydrophilicity of the resulting substrate is increased by mild plasma treatment with minimal loss of original topography and substructure, e.g., undetectable at, say, 5000× magnification or lower. Thus the invention provides specific, optimally shaped polymeric substrates whose hydrophilicity is increased without significantly altering the desired shape.

The materials of the present invention are useful in various applications relying on biologic adsorption, e.g., protein adsorption, including diagnostic tests and other medical uses such as anastomosis devices, grafts, vascular prosthetic devices, soft tissue implants.

In one aspect, disclosed herein is a biologic adsorbent structure comprising a polymeric substrate having a substantially fixed topography, the substantially fixed topography comprising substructures having dimensions ranging from about 100 nanometers to about 50 microns, the substructures formed by contact with a shaped surface for imparting increased surface area to at least one surface thereof, the polymeric substrate formed from a polymeric material comprising a cyclic poly(olefin), a non-cyclic polyolefin or blends thereof, wherein the at least one surface is plasma-treated.

In another aspect, disclosed herein is a method for preparing a biologic adsorbent structure which comprises contacting a polymeric mass comprising a cyclic poly(olefin), a non-cyclic polyolefin, or blends thereof, with a shaped surface to form a polymeric substrate having an increased surface area on at least one surface of the polymeric substrate to provide a surface of substantially fixed topography, and plasma-treating the at least one surface of substantially fixed topography to increase wettability as measured by water contact angle, without substantially altering the topography.

In still another aspect, disclosed herein is a method for modulating the amount of biologic uptake of a polymeric structure mass comprising a cyclic poly(olefin), a non-cyclic polyolefin, or blends thereof, the polymeric structure having a substantially fixed topography and high surface area whose biologic uptake is otherwise not a function of surface area which comprises surface treating the polymeric structure by plasma treatment to increase wettability without substantially altering the topography.

### BRIEF DESCRIPTION OF THE DRAWINGS

FIG. 1 depicts a SEM image of a polypropylene (PP) structure comprising pillars of about 1 micron diameter and 20 microns height fabricated using a polycarbonate membrane as a mold and an imprinting process.

FIG. 2 depicts a graph showing protein uptake for the protein albumin by substrates of fixed topography with increased surface area (as normalized to flat film). The substrates are polypropylene structures comprising pillars of about 1 micron diameter and 20 microns height fabricated using a polycarbonate membrane as a mold and an imprinting process. One substrate, Plasma-treated Pillars, is a plasma-treated polypropylene (PP) film with pillars providing uptake of protein that is markedly higher than Untreated Flat, Untreated Pillars, or Plasma-treated Flat. Protein uptake is normalized to the surface area of a flat film.

FIG. 3 depicts a graph showing protein uptake for the protein fibrinogen by substrates of fixed topography with increased surface area (as normalized to flat film). The substrates are polypropylene structures comprising pillars of about 1 micron diameter and 20 microns height fabricated using a polycarbonate membrane as a mold and an imprinting process. One substrate, Plasma-treated Pillars, is a plasma-treated polypropylene (PP) film with pillars providing uptake of protein that is markedly higher than Untreated Flat, Untreated Pillars, or Plasma-treated Flat. Protein uptake is normalized to the surface area of a flat film.

FIG. 4 depicts a graph showing protein uptake for the protein lysozyme by substrates of fixed topography with increased surface area (as normalized to flat film). The substrates are polypropylene structures comprising pillars of about 1 micron diameter and 20 microns height fabricated using a polycarbonate membrane as a mold and an imprinting process. One substrate, Plasma-treated Pillars, is a plasma-treated polypropylene (PP) film with pillars providing uptake of protein that is markedly higher than Untreated Flat, Untreated Pillars, or Plasma-treated Flat. Protein uptake is normalized to the surface area of a flat film.

FIG. 5 depicts a SEM image of a structure fabricated by casting of biodurable poly(dimethylsiloxane) (PDMS) comprising pillars having a diameter of 3 microns and a height of 3 microns, which pillars are spaced apart by 1 micron.

FIG. 6 depicts a SEM image of a structure fabricated by casting of biodurable poly(dimethylsiloxane) (PDMS) comprising pillars having a diameter of 3 microns and a height of 6 microns, which pillars are spaced apart by 1 micron.

FIG. 7 depicts a SEM image of a structure fabricated by casting of biodurable poly(dimethylsiloxane) (PDMS) comprising pillars having a diameter of 3 microns and a height of 9 microns, which pillars are spaced apart by 1 micron.

FIG. 8 depicts a SEM image of a structure fabricated by casting of biodurable poly(dimethylsiloxane) (PDMS) comprising pillars having a diameter of 3 microns and a height of 12 microns, which pillars are spaced apart by 1 micron.

FIG. 9 is a graph showing the linearity of protein uptake for three proteins—albumin, fibrinogen, and lysozyme—by substrates of fixed topography with increasing surface areas (as normalized to flat film). The substrates are plasma-treated poly(dimethylsiloxane) polymer (PDMS).

FIG. 10 is a graph showing the lack of linearity of protein uptake for three proteins—albumin, fibrinogen, and lysozyme—by untreated substrates of fixed topography with increasing surface areas (as normalized to flat film). The substrates, which are not plasma treated, exhibit limited surface wettability.

FIG. 11 depicts a SEM image of a structure fabricated by imprinting of bioabsorbable poly(lactic-co-glycolic acid) (PLGA) comprising pillars having a diameter of 10 microns and a height of 10 microns, which pillars are spaced apart by 50 microns.

FIG. 12 depicts a SEM image of a structure fabricated by imprinting of bioabsorbable poly(lactic-co-glycolic acid) (PLGA) comprising pillars having a diameter of 10 microns and a height of 10 microns, which pillars are spaced apart by 20 microns.

FIG. 13 depicts a SEM image of a structure fabricated by imprinting of bioabsorbable poly(lactic-co-glycolic acid) (PLGA) comprising pillars having a diameter of 10 microns and a height of 10 microns, which pillars are spaced apart by 10 microns.

FIG. 14 depicts a SEM image of a structure fabricated by imprinting of bioabsorbable poly(lactic-co-glycolic acid) (PLGA) comprising pillars having a diameter of 10 microns and a height of 10 microns, which pillars are spaced apart by 6 microns.

FIG. 15 depicts a graph showing the linearity of protein uptake for three proteins—albumin, fibrinogen, and lysozyme—by substrates of fixed topography with increasing surface areas (as normalized to flat film). The substrates are plasma-treated poly(lactic-co-glycolic acid) (PLGA).

FIG. 16 depicts a graph showing the lack of linearity of protein uptake for three proteins—albumin, fibrinogen, and lysozyme—by untreated substrates of poly(lactic-co-glycolic acid) (PLGA) having fixed topography with increasing surface areas (as normalized to flat film). The substrates are not plasma treated and exhibit limited surface wettability.

FIG. 17 depicts an SEM image showing the cyclic poly(olefin) high surface area pillars.

FIG. 18 depicts the albumin uptake on cyclic poly(olefin) flat film untreated, cyclic poly(olefin) pillars untreated, cyclic poly(olefin) flat film plasma treated, and cyclic poly(olefin) pillars plasma treated.

FIG. 19 depicts the fibrinogen uptake on cyclic poly(olefin) flat film untreated, cyclic poly(olefin) pillars untreated, cyclic poly(olefin) flat film plasma treated, and cyclic poly(olefin) pillars plasma treated.

FIG. 20 depicts the lysozyme uptake on cyclic poly(olefin) flat film untreated, cyclic poly(olefin) pillars untreated, cyclic poly(olefin) flat film plasma treated, and cyclic poly(olefin) pillars plasma treated.

### DETAILED DESCRIPTION OF THE INVENTION

The present invention provides substrates which are tailored to control their adsorbing of, biological entities (or biologics). For present purposes, substrates are structures which exhibit three-dimensional characteristics (as opposed to substantially flat structures). For example, structures can include shaped solids, as well as films having a surface which has been modified to increase surface area, e.g., by casting, imprinting (including nanoimprinting), by at least about 1.01 times, say, at least about 1.1 times, at least about 2 times, or even at least about 20 times, that of a corresponding unmodified flat film.

Biologics, for present purposes, include sugars, proteins, lipids, nucleic acids, polynucleotides or complex combinations of these substances, as well as living entities such as cells and tissues. Biologics can be isolated from a variety of natural sources—human, animal, or microorganism—and may be produced by biotechnology methods and other technologies. In some instances, biologics can be prepared using non-biological, chemical methods. Biologics include a wide range of medicinal products such as vaccines, blood and blood components, allergenics, somatic cells, gene therapy, tissues, and recombinant therapeutic proteins created by biological processes (as distinguished from chemistry).

Biologic, e.g., protein, adsorbent material made from polymer or comprising polymer can be formed into structures having high surface area topography. Structures can have tailored geometric features including substructures, e.g., pillars, with a diameter from 0.1-50 microns (100-50000 nm) and height greater than 1 micron (>1000 nm), which provide surface area greater than that of a substrate comprised of exposed flat surfaces. Protein adsorbency of, a substrate is not dependent on surface area alone. It has now been found that in order to effectively utilize increased surface area of a substrate, adsorption by the substrate surface comprising substructures can be optimized by mildly treating the surface to improve wettability, without substantially altering the surface of the substructures. Thus, polymeric structures of desirable high surface area topography exhibit improved biologics adsorption by mild treating of the surfaces, e.g., by oxygen plasma, provided such treating is carried out without substantially altering topography of the surfaces.

Suitable substructures can include protrusions having an average diameter ranging from 100 nanometers to 50 microns, an average height greater than 1 micron and an aspect ratio (height/diameter) of 0.1 to 50. The protrusions typically have an average diameter ranging from 1 to 10 microns, an average height greater than 3 microns and an aspect ratio (height/diameter) of 1 to 20.

Structures of the present invention can be integrally molded from a resin selected from at least one of thermoplastic polymer(s) and thermosetting polymer(s). By integrally molded is meant that the structure is formed in one piece, including its substructures, e.g., protrusions, from a mold. For present purposes, thermoplastic polymer softens when heated and hardens again when cooled. Thermosetting polymers undergo cross-linking of their polymer chains, brought about by chemical additives, ultraviolet radiation, electron beam, and/or heat.

In one embodiment, the polymer is a biodegradable polymer. For present purposes, a biodegradable polymer is a polymer capable of being decomposed by the action of biological agents, e.g., bacteria, enzymes or water.

In another embodiment, the polymer is a non-biodegradable polymer. For present purposes, a non-biodegradable polymer is a polymer that is not capable of being decomposed by the action of biological agents, e.g., bacteria, enzymes, or water.

For present purposes, wettability of surfaces can be determined according to static water contact angle measurements conducted using a sessile drop method. For the present invention, water contact angles of less than 60° are considered wettable and water contact angles of 60° or greater are considered non-wettable.

As earlier noted, in one aspect the present invention relates to a biologic adsorbing structure having a polymer-containing substrate comprising: i) a substantially fixed topography comprising substructures comprising dimensions that range from about 100 nanometers to about 50 microns, the topography being formed by contact with a shaped surface imparting increased surface area compared to a flat surface; and ii) a plasma-treated surface.

In an embodiment of this aspect, the structure's plasma-treated surface has a water contact angle no greater than 60 degrees.

In another embodiment of this aspect, the polymer provides a water contact angle of 60 degrees or greater when tested in the form of a flat non-plasma-treated film, or in the form of a non-plasma-treated film with substructures. The polymer can be selected from poly(dimethyl)siloxane (PDMS), polypropylene (PP), and poly(lactic-co-glycolic acid) (PLGA).

In yet another embodiment of this aspect, the polymer is a thermosetting polymer. The polymer can be selected from poly(dimethyl)siloxane (PDMS).

In yet another still embodiment of this aspect, the structure's topography is a cast topography, i.e., the contacting is carried out by casting. The casting can use a mold prepared by at least one of photolithography and polycarbonate membrane.

In yet still another embodiment of this aspect, the polymer is a thermoplastic polymer. Typically, the polymer is selected from at least one of poly(lactic-co-glycolic acid) (PLGA) and polypropylene (PP).

In another form, the polymer includes a cyclic poly(olefin), a non-cyclic polyolefin or blends thereof. Cyclic olefin homopolymers and copolymers are engineering thermoplastics derived from the ring-shaped norbornene molecule, which is made from dicyclopentadiene and ethylene. Cyclic poly(olefin)s are amorphous, possessing a cyclic structure in the main chain. Typically, they are polymerized by ring opening metathesis polymerization of norbornene or norbornene derivatives, followed by hydrogenation of double bonds. The hydrogenation of the double bonds is thought to provide more stability in terms of heat and weather resistance.

Suitable cyclic poly(olefin)s may be synthesized according to the scheme depicted below:

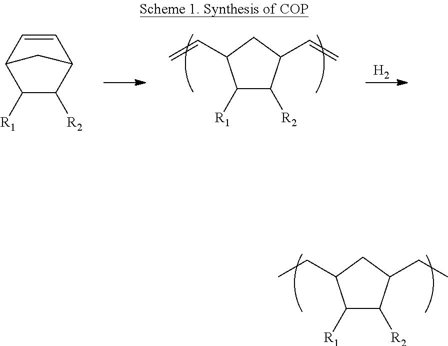

Other cyclic poly(olefin)s have utility in the practice of the present invention. In one form, the polymer includes an addition copolymer of a norbornene derivative, with a nonpolar group and ethylene. The synthesis of such an addition copolymer may be depicted as in Scheme 2.

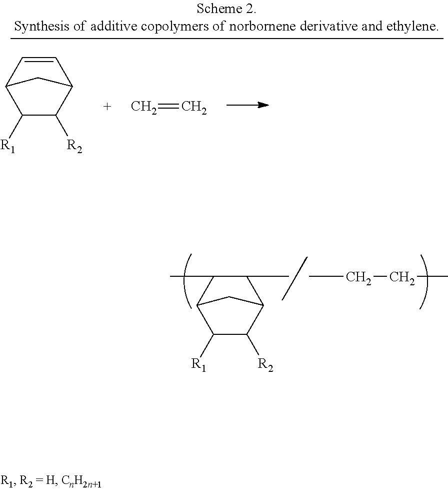

Suitable cyclic poly(olefin)s are commercially available from a wide variety of sources. One such material is available from Zeon Chemicals, L.P. of Louisville, Ky., and is marketed under the tradename Zeonor 1060R. Zeonor 1060R may be obtained in the form of film from the manufacturer.

In yet another embodiment, the polymeric structure imprinted by nanoimprinting or hot embossing. Imprinting or hot embossing is essentially the molding or stamping of a pattern into a polymer softened by raising the temperature of the polymer just above its glass transition temperature. The mold or stamp used to define the pattern in the polymer may be made in a variety of ways including photolithography, e-beam lithography, and polycarbonate membranes.

In another embodiment of this aspect, the plasma-treated surface is treated with oxygen plasma. Typically, the plasma-treated surface is treated at 50 to 150 watts for 15 to 45 seconds, say, e.g., at 75 to 125 watts for 25 to 35 seconds.

In yet another embodiment of this aspect of the invention, the plasma-treated surface is treated under conditions sufficient to increase wettability to an extent sufficient to provide a water contact angle of no greater than 60 degrees without substantially altering the topography.

In still yet another embodiment of this aspect, the topography comprises pillar-like substructures having an average cross-section width ranging from 100 nanometers to 50 microns, an average height ranging from 1 to 50 microns, and an aspect ratio ranging from 0.1 to 50 say, having an average cross-section width ranging from 1 to 10 microns, an average height ranging from 3 to 20 microns, and an aspect ratio ranging from 1 to 20.

In still yet another embodiment of this aspect, the ratio of increased surface area compared to a flat surface is at least 1.01, say, at least 1.1, e.g., at least 2, at least 5, or even at least 20.

In another embodiment of this aspect of the invention, the pillar-like substructures are spaced apart at an average inter-structural spacing of from 100 nanometers to 100 microns, say, at an average inter-structural spacing of from 1 to 50 microns. Alternatively, for highly-densely packed structures, a “protrusion density” can be described as the number of protrusions or pillars present per square centimeter of adhesive structure surface. The pillar-like substructures have a protrusion density of from 1×10⁵ to 6×10⁸ protrusions/cm², say, from about 1×10⁷ to about 5×10⁷ protrusions per cm².

As earlier noted, in one aspect the present invention relates to a diagnostic test device comprising the structure of claim 1 whose surface is capable of adsorbing a biologic analyte. Suitable applications include detecting levels of analytes that include body fluid assays such as blood, serum, bile, urine, saliva and cerebrospinal fluid.

As noted previously, in another aspect, the present invention relates to a method for preparing a biological entity adsorbent structure which comprises: a) contacting a polymeric mass with a shaped surface to impart increased surface area compared to a flat surface and provide a surface of substantially fixed topography; and b) plasma-treating the surface of substantially fixed topography to increase wettability as measured by water contact angle, without substantially altering the topography.

In another embodiment of this aspect of the invention, the polymer provides a water contact angle of 60 degrees or greater when tested in the form of a flat non-plasma-treated film, or in the form of a non-plasma-treated film with substructures. The polymer can be selected from poly(dimethyl)siloxane (PDMS), polypropylene (PP), and poly(lactic-co-glycolic acid) (PLGA).

In yet another embodiment of this aspect of the invention, contacting is carried out by casting. The casting can use a mold prepared by at least one of photolithography and polycarbonate membrane.

In yet still another embodiment of this aspect of the invention, the plasma-treated surface is treated with oxygen plasma. The plasma-treated surface is treated at 50 to 150 watts for 15 to 45 seconds, say, at 75 to 125 watts for 25 to 35 seconds.

In another embodiment of this aspect of the invention, the plasma-treated surface is treated under conditions sufficient to increase wettability to an extent sufficient to provide a water contact angle of no greater than 60 degrees, without substantially altering the topography.

In still another embodiment of this aspect of the invention, the topography comprises pillar-like substructures having an average cross-section width ranging from 100 nanometers to 50 microns, an average height ranging from 1 to 50 microns, and an aspect ratio ranging from 0.1 to 50, say, an average cross-section width ranging from 1 to 10 microns, an average height ranging from 3 to 20 microns, and an aspect ratio ranging from 1 to 20.

In yet another embodiment of this aspect of the invention, the ratio of increased surface area compared to a flat surface is at least 1.01, say, at least 1.1, at least 2, at least 5, or even at least 20.

In yet still another embodiment of this aspect of the invention, the pillar-like substructures are spaced apart at an average inter-structural spacing of from 100 nanometers to 100 microns, say, at an average inter-structural spacing of from 1 to 50 microns. Alternatively, for highly-densely packed structures, a “protrusion density” can be described as the number of protrusions or pillars present per square centimeter of adhesive structure surface. The pillar-like substructures have a protrusion density of from 1×10⁵ to 6×10⁸ protrusions/cm², say, from about 1×10⁷ to about 5×10⁷ protrusions per cm².

In still another aspect, the present invention relates to a method for modulating the amount of biologic uptake of a polymeric structure of substantially fixed topography and high surface area whose biologic uptake is otherwise not a function of surface area which comprises: surface treating the structure by plasma treatment to increase wettability without substantially altering the topography.

In an embodiment of this aspect of the invention, the increase in wettability is determined by measuring a reduction in water contact angle for the treated surface compared to the untreated surface.

In another embodiment of this aspect of the invention, the biologic is selected from at least one of sugar, lipid, protein, nucleic acid, and polynucleotide, say, e.g., protein.

In still another embodiment of this aspect of the invention, the plasma treatment is oxygen plasma treatment.

The invention is further explained in the description that follows with reference to the drawings illustrating, by way of non-limiting examples, various embodiments of the invention.

### Example 1

This example shows that densely-packed structures of high aspect ratio can be plasma-treated to provide large increases in surface area that are wettable and thus result in increased protein uptake. Polypropylene pillars of diameter 1 micron and height 20 micron were fabricated using a polycarbonate membrane as a mold and a nanoimprinting process as follows: A commercial track etched polycarbonate membrane was obtained from Millipore Corporation of Billerica, Mass., USA of having pores of 1 micron diameter and a circular diameter of 2.5 cm, with a thickness of 20 micron. The membrane was used as a template to imprint a solvent-resistant polypropylene polymer film of 300 micron thickness, obtained from Ethicon, Inc. of New Brunswick, N.J., USA. The polypropylene film was pressed into the polycarbonate membrane template under high temperature and pressures (180° C., 600 kPa (6 bar)) for 20 minutes, melting the polypropylene. The polypropylene polymer and the membrane are cooled to 175° C. before removal of pressure, after which the polymer structures are de-molded and released by dissolving the membrane in dichloromethane.

Any thermoformable material can be substituted for polypropylene as the substrate or core material. The porous solvent-dissolvable polycarbonate material which acts as a template for the pillar-like protrusions of the product can be substituted by another solvent-dissolvable porous polymeric material. Alternately, a strippable mold such as anodized aluminum oxide can be substituted to provide the pillar-like cylindrical protrusions of the final product, without the need for exposure to a chemical solvent. A polyimide film sold under the trademark KAPTON by E. I. du Pont de Nemours and Company Corporation of Wilmington, Del., USA, was used as a capping means or shield to protect polymer surfaces from directly contacting surfaces such as metal. Other suitable substantially chemically inert materials which can also be provided as a film or other layer for this purpose include polytetrafluoroethylene sold under the trademark TEFLON by E. I. du Pont de Nemours and Company Corporation of Wilmington, Del., USA. Advantageously, these materials are not reactive with the polycarbonate solvent-dissolvable mold or template material and can be readily removed or peeled therefrom once compression is completed.

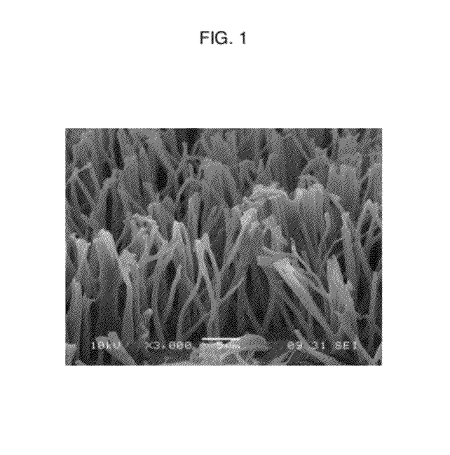

The surface area ratio for these structures is 6.5 times the surface area of a flat film as shown by FIG. 1 which depicts an SEM image showing the polypropylene high surface area pillars.

Static water contact angle measurements, herein referred to as contact angle measurements, were conducted using a sessile drop method. A Rame-Hart contact angle goniometer with Drop Image software was used. Plasma treatment was done immediately before contact angle measurement. 2 microliter drops of de-ionized water were placed on the surface for measurement, and 5 measurements were taken for each surface. The mean contact angle is reported.

The contact angle of these structures is higher than the corresponding flat film (148 degrees vs 101 degrees), implying their greater hydrophibicity or non-wettability. Oxygen plasma treatment reduces the contact angle for water on these surfaces, as shown in TABLE 1 below, resulting in wettable surfaces (and greater hydrophilicity). Oxygen plasma treatment was conducted using a microwave plasma processor (100 W, 30 seconds).

TABLE 1

Water Contact Angles

| | Untreated | Plasma-treated |
|---|---|---|
| Flat | 101 | 59 |
| Pillars | 148 | 14 |

The protein adsorption or protein uptake properties of these samples were evaluated by incubating the samples in protein solution and assaying using the bicinchoninic acid (BCA) assay. Films were cut into 1×1 cm pieces and incubated in 1 ml of protein solution (2 mg/ml in phosphate buffered saline (PBS)) in a sealed 24-well plate overnight (18 hrs) with orbital shaking. After protein incubation the films were removed from the wells and washed in 3 consecutive baths of PBS and then immediately quantified using the BCA Assay.

The BCA assay was conducted as follows: protein standards were made using the bovine serum albumin (BSA) standard provided in the BCA kit (QuantiPro BCA kit, Sigma Aldrich). Rinsed films were placed in wells of a 24-well plate containing 500 microliters PBS+500 microliters BCA reagent (prepared as per kit instructions). For protein standards, 500 microliters of protein standard solution was placed in the well with 500 microliters BCA reagent. The plate was sealed and protected from light and incubated with orbital shaking at 50 rpm for 2 hrs at 37° C. After incubation, 200 microliters of the solution was transferred to wells of 96-well plate for absorbance reading at 562 nm.

A range of proteins was tested that had different shapes, sizes, and charges, as shown in TABLE 2 below. These proteins serve as model proteins for other biological entities.

TABLE 2

| Protein | Shape | Size | | Charge |
|---|---|---|---|---|
| Albumin | Globular | ~15 | nm | − |
| Fibrinogen | Rod-like | ~5 × 45 | nm | − |
| Lysozyme | Globular | ~4 | nm | + |

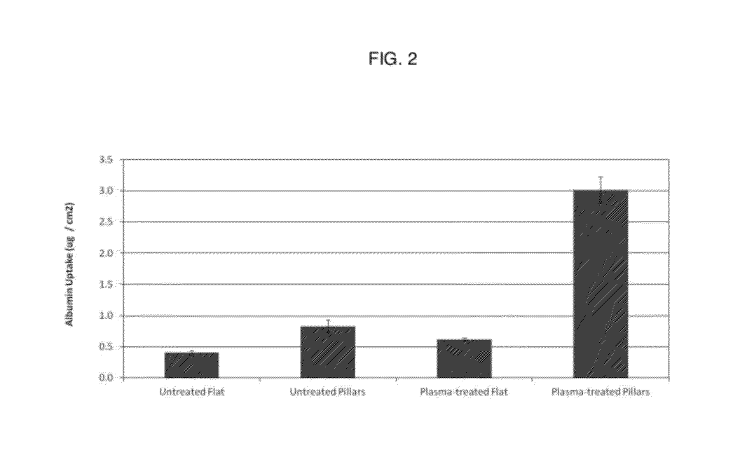

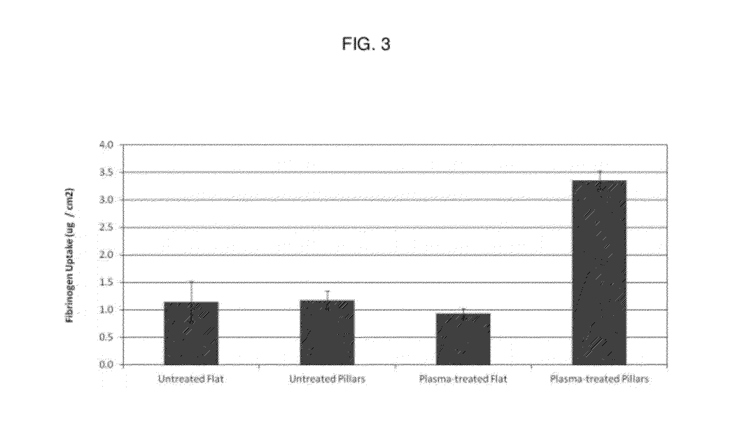

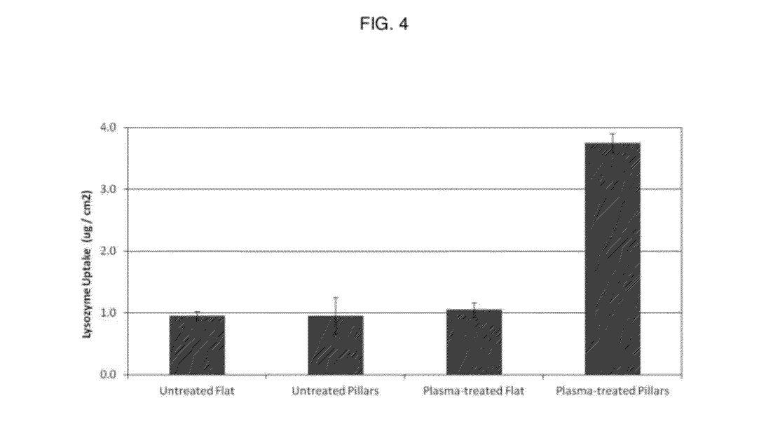

The untreated flat film, untreated pillars, and plasma-treated flat film exhibit similar levels of protein adsorption. However, the combination of pillars (high surface area structures) with plasma treatment provides a large increase in protein uptake. This trend was observed for albumin, fibrinogen, and lysozyme in FIG. 2, FIG. 3, and FIG. 4 below, respectively.

### Example 2

PDMS films were fabricated that contained patterned pillars (substructures) of varied height. A casting process was used to fabricate the structures, keeping constant the diameter and spacing of substructure. PDMS monomer was mixed with 1:10 ratio of curing agent (Sylgard 184 silicone elastomer kit, Dow Corning) and degassed. Si molds were placed face up in aluminum pans and the PDMS solution was poured over the top to a thickness of 1-2 mm. The pans were degassed and then cured a vacuum oven at 60° C. for 4 hrs under vacuum. The cured PDMS was then peeled from the molds. A systematic increase in surface area was achieved through this technique, where the increase in surface area is due to the surface topography. Pillar dimensions are expressed in TABLE 3 below in terms of diameter×spacing×height (in microns).

TABLE 3

| | | 3 × | | | |
|---|---|---|---|---|---|
| | | 1 × 3 μm | 3 × 1 × 6 μm | 3 × 1 × 9 μm | 3 × 1 × 12 μm |
| | Flat | Pillars | Pillars | Pillars | Pillars |
| Surface | 1.0 | 1.8 | 2.6 | 3.4 | 4.2 |
| area | | | | | |
| ratio | | | | | |
| (vs flat) | | | | | |

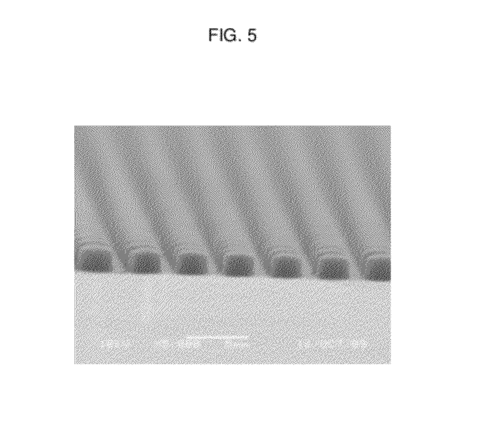

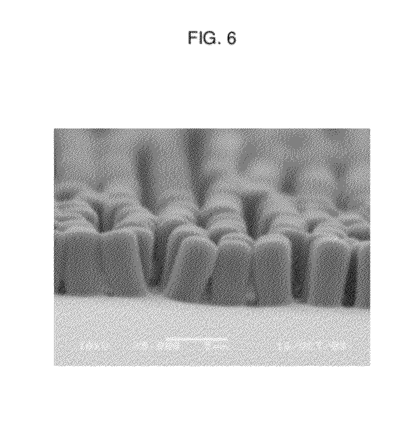

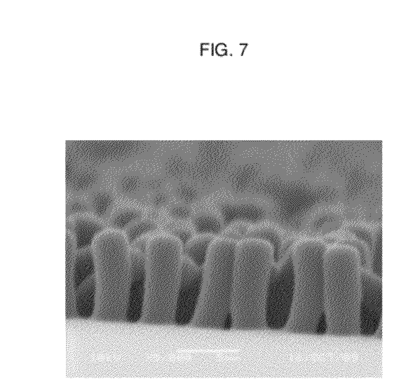

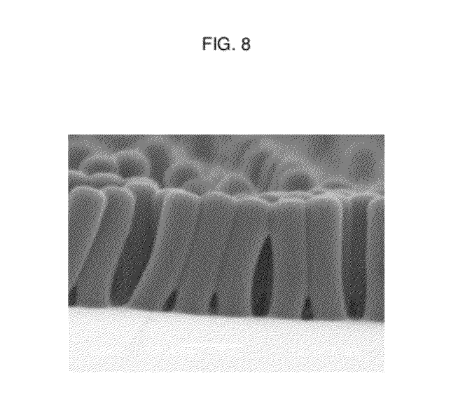

FIGS. 5, 6, 7, and 8 depict SEM images of the respective structures fabricated with PDMS respectively varying in height—3, 6, 9, and 12 microns, respectively. Diameter was kept constant at 3 microns and spacing was kept constant at 1 micron.

Untreated patterned pillar structures exhibit higher contact angles than flat substrates, as shown in TABLE 4 below. The tallest structures (3 microns×1 micron×12 microns) had the highest contact angle value. Oxygen plasma treatment improved the wettability of all of the structures as reflected by water contact angles. The oxygen plasma treatment was conducted using a microwave plasma processor (100 W, 30 seconds).

TABLE 4

| | Water Contact Angle | | | | |
|---|---|---|---|---|---|
| | | 3 × 1 × | | | |
| | | 3 μm | 3 × 1 × 6 μm | 3 × 1 × 9 μm | 3 × 1 × 12 μm |
| | Flat | Pillars | Pillars | Pillars | Pillars |
| Untreated | 111 | 139 | 135 | 141 | 152 |
| Plasma- | <20 | <20 | <20 | <20 | <20 |
| treated | | | | | |

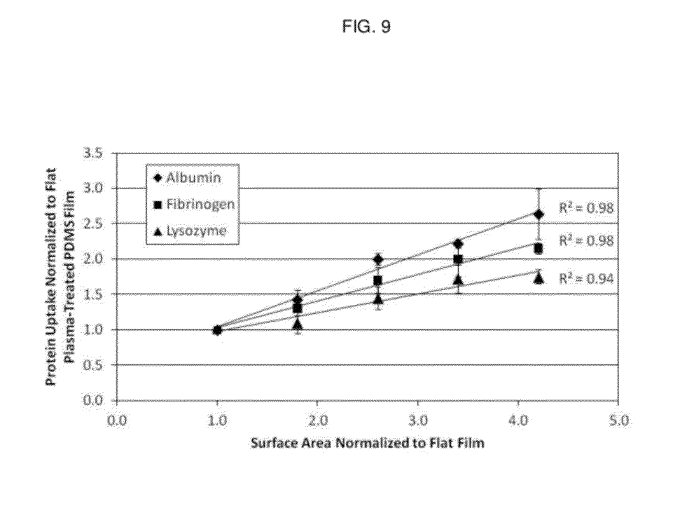

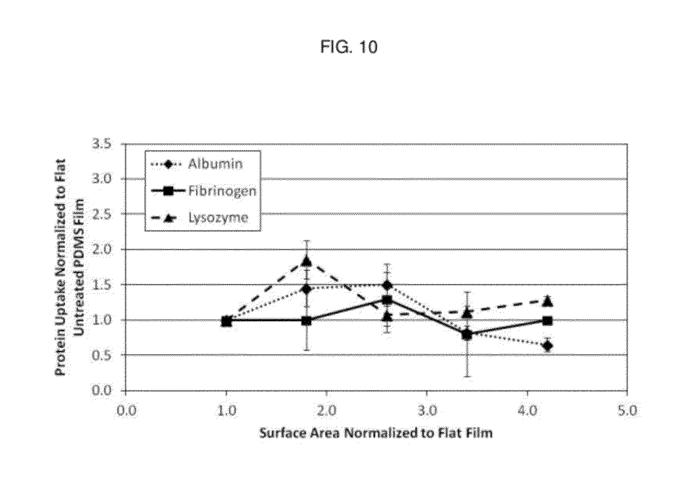

Increasing the surface area of a wettable surface enhances protein uptake proportionally. This can be seen by the linear trend shown in the plasma-treated PDMS graph of FIG. 9 but not in the untreated PDMS graph of FIG. 10 By choosing the appropriate height, the surface can be modified or “tuned” to achieve a specific amount of protein uptake.

### Example 3

PLGA films were fabricated that contained patterned pillars (substructures) of varied spacing. An imprinting process was used to fabricate the structures, keeping constant the diameter and height of the substructures. PLGA 85/15 resin obtained from Purac America of Lincolnshire, Ill., USA, was compression molded using heat and pressure to form films at 356° F. and 10,000 lbs. PLGA films were cut to the size of the Si molds and placed on top of the molds for imprinting. Imprinting was performed at 80° C. and 60 bar for 300 seconds. The pressure was released at 40° C. and the films were peeled from the molds. A systematic increase in surface area was achieved through this technique, where the increase in surface area is due to the surface topography. Pillar dimensions are expressed in TABLE 5 below in terms of diameter×spacing×height (in microns).

TABLE 5

| | | 10 × 50 × | 10 × 20 × | 10 × 10 × | 10 × 6 × |
|---|---|---|---|---|---|
| | | 10 μm | 10 μm | 10 μm | 10 μm |
| | Flat | Pillars | Pillars | Pillars | Pillars |
| Surface area | 1 | 1.1 | 1.2 | 1.4 | 1.6 |
| ratio (vs. flat) | | | | | |

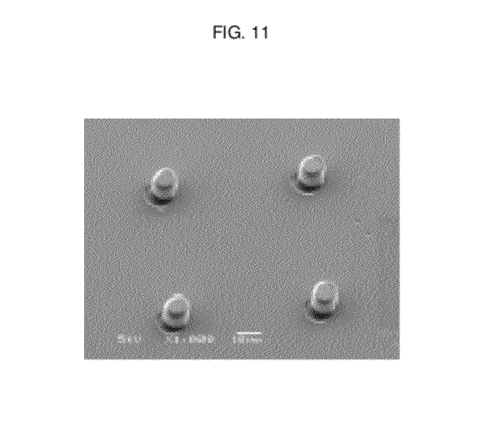

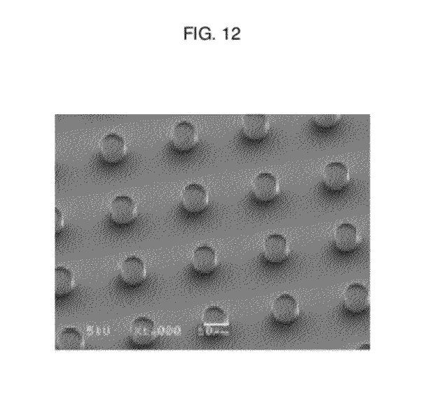

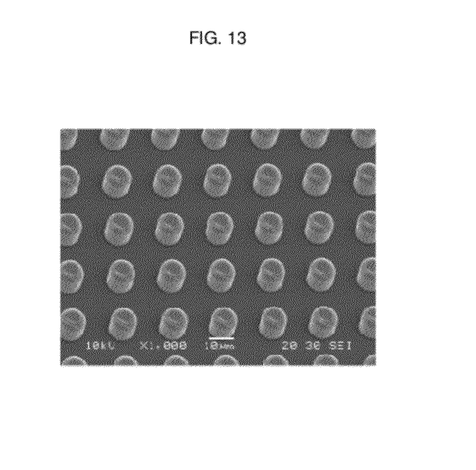

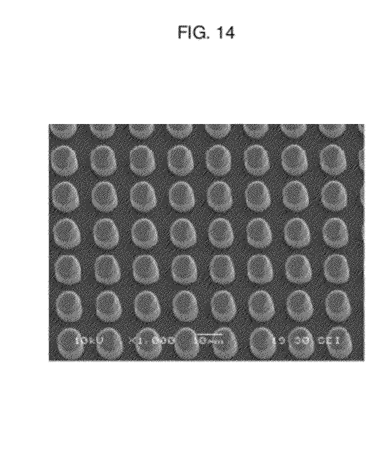

FIGS. 11, 12, 13 and 14 depict SEM images of the respective structures fabricated with PLGA respectively varying in spacing—50, 20, 10, and 6 microns, respectively. Diameter and height are kept constant at 10 microns.

As pillar spacing is reduced, the water contact angle increases. Oxygen plasma treatment decreases the contact angle to about the same value for all four plasma-treated structures and the flat substrate as shown below in TABLE 6. Oxygen plasma treatment was conducted using microwave plasma processor (100 W, 30 seconds).

TABLE 6

| | Water Contact Angle | | | | |
|---|---|---|---|---|---|
| | | 10 × 50 × | 10 × 20 × | 10 × 10 × | 10 × 6 × |
| | | 10 μm | 10 μm | 10 μm | 10 μm |
| | Flat | Pillars | Pillars | Pillars | Pillars |
| Untreated | 77 | 89 | 97 | 106 | 119 |
| Plasma-treated | 51 | 53 | 54 | 54 | 51 |

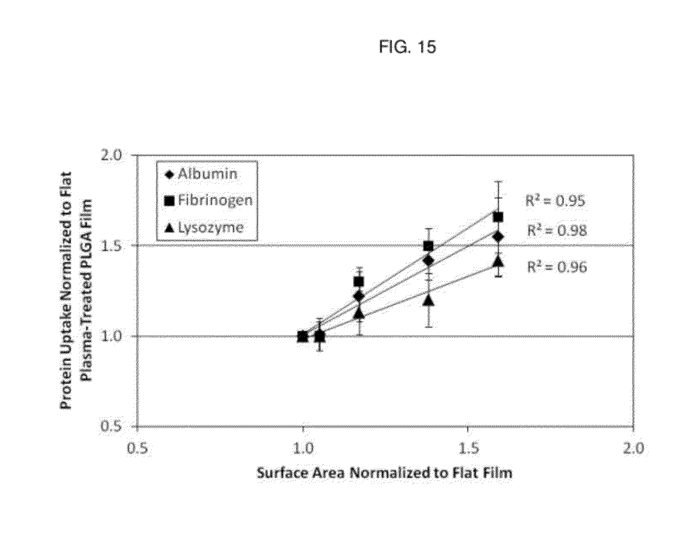

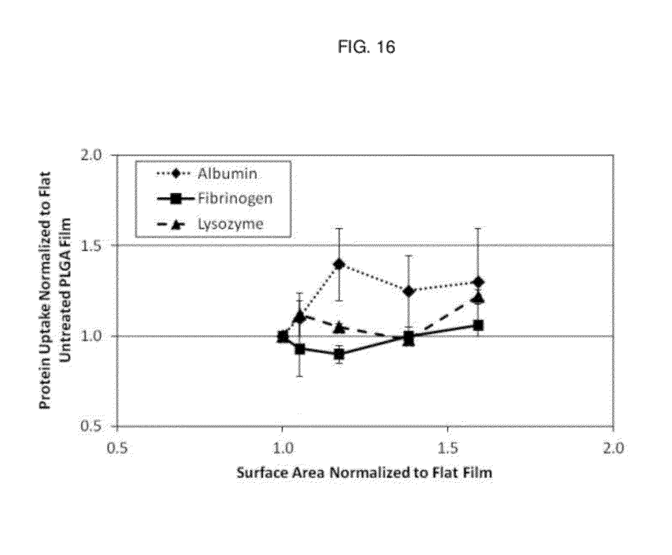

Increasing the surface area of a wettable surface enhances protein uptake proportionally. This can be seen in the linear trend observed for FIG. 15 in the plasma-treated PLGA graph, but not in FIG. 16 for the untreated PLGA graph. By choosing the appropriate spacing between pillars or other substructure, the surface can be tuned to achieve a specific level of protein uptake.

### Example 4

Pillars of 3 micron diameter and height of 15 micron diameter were fabricated on both sides of a cyclic poly(olefin) film using two polycarbonate membranes as a mold and an imprinting process as follows: A commercial track etched polycarbonate membrane was obtained from Millipore Corporation of Billerica, Mass., USA of having pores of 3 micron diameter and a circular diameter of 4.5 cm, with a thickness of 20 micron. The membrane was used as a template to imprint a solvent-resistant cyclic poly(olefin) polymer film (sold under the tradename Zeonor 1060R, Zeon Chemicals, L. P., Louisville, Ky.) having a 1.2 millimeter thickness. The cyclic poly(olefin) film was pressed into the polycarbonate membrane template under high temperature and pressures (170° C., 6000 kPa (60 bar)) for 5 minutes, melting the cyclic poly(olefin). The imprinted film was subjected to a second imprinting step using the same conditions with the polycarbonate membrane on the reverse side of the cyclic poly(olefin) film, after which the polymer structures are de-molded and released by dissolving the polycarbonate membrane in dichloromethane.

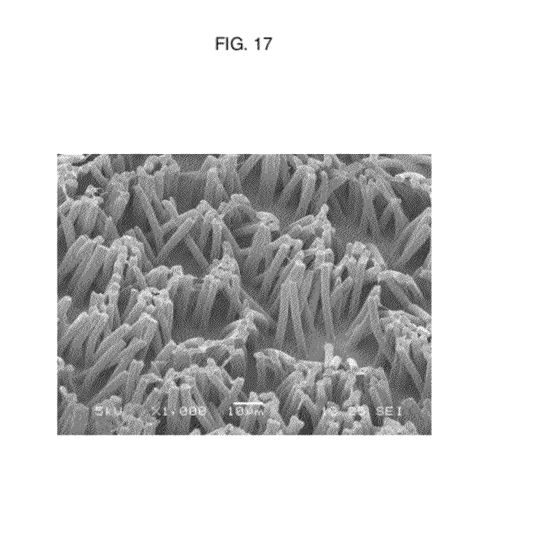

The surface area ratio for the cyclic poly(olefin) structures is 4 times the surface area of a flat film as shown by FIG. 17 which depicts an SEM image showing the cyclic poly(olefin) high surface area pillars.

The water contact angle of these structures is higher than the corresponding flat film (137 degrees vs. 92 degrees for cyclic poly(olefin)), implying their greater hydrophibicity or non-wettability. Oxygen plasma treatment reduces the contact angle for water on these surfaces, as shown in TABLE 7 below, resulting in wettable surfaces (and greater hydrophilicity).

Oxygen plasma treatment was conducted using a microwave plasma processor (100 W, 30 seconds).

TABLE 7

Water Contact Angles
Cyclic Poly(olefin)

| | Untreated | Plasma-treated |
|---|---|---|
| Flat | 92 | 20 |
| Pillars | 137 | <10 |

The protein adsorption or protein uptake properties of these samples were evaluated by incubating the samples in protein solution and assaying using the bicinchoninic acid (BCA) assay, as previously outlined in Example 1.

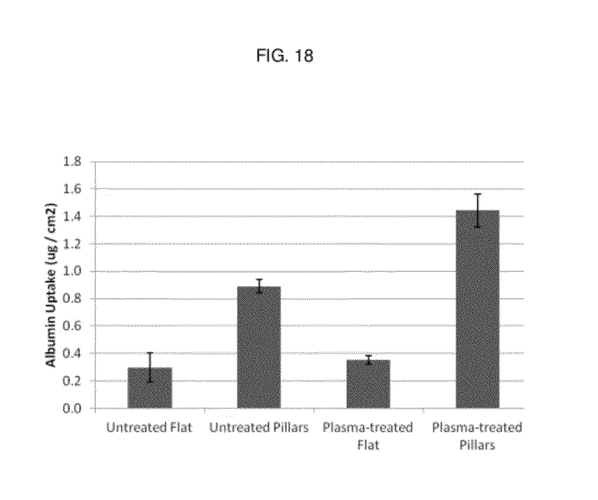

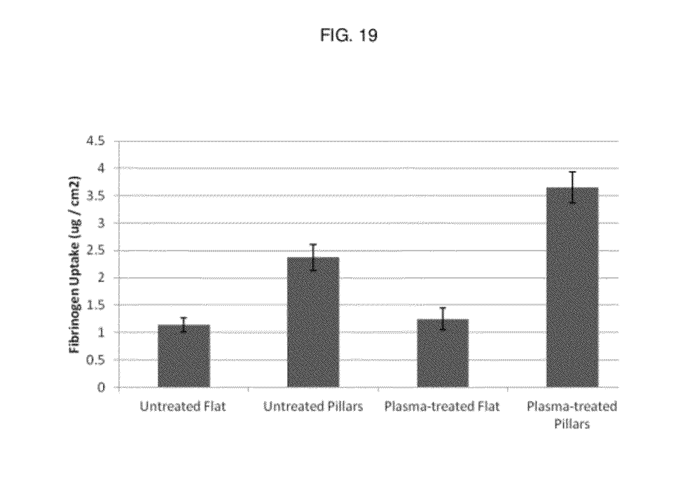

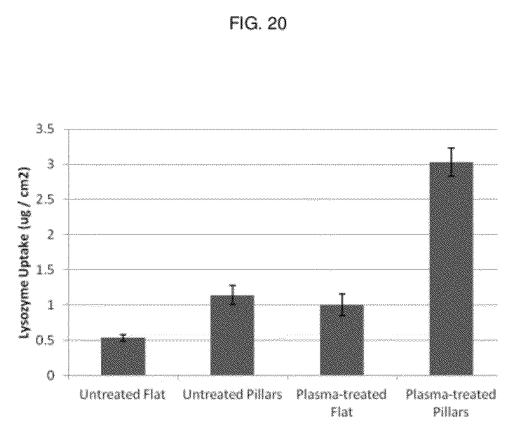

The untreated and plasma-treated flat films exhibited similar levels of protein adsorption. The untreated pillar films had increased protein adsorption levels compared to flat films. However, the combination of pillars (high surface area structures) with plasma treatment provides a large increase in protein uptake over both flat films and untreated pillars. This trend was observed for albumin, fibrinogen, and lysozyme in FIG. 18, FIG. 19, and FIG. 20, respectively.

All patents, test procedures, and other documents cited herein, including priority documents, are fully incorporated by reference to the extent such disclosure is not inconsistent and for all jurisdictions in which such incorporation is permitted.

When numerical lower limits and numerical upper limits are listed herein, ranges from any lower limit to any upper limit are contemplated.

Without further elaboration, it is believed that one skilled in the art can, using the preceding description, utilize the present invention to its fullest extent. While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the invention.

What is claimed:

1. A biologic adsorbent structure comprising a polymeric substrate having a substantially fixed topography, said substantially fixed topography comprising substructures having dimensions ranging from about 100 nanometers to about 50 microns, said substructures formed by contact with a shaped surface for imparting increased surface area to at least one surface thereof, said polymeric substrate formed from a polymeric material comprising a cyclic poly(olefin), a non-cyclic polyolefin or blends thereof, wherein said at least one surface is plasma-treated.

2. The structure of claim 1, wherein said polymeric material comprises a cyclic poly(olefin).

3. The structure of claim 2, wherein said cyclic poly(olefin) comprises an amorphous polyolefin having a cyclic structure polymerized by ring opening metathesis polymerization of norbornene or norbornene derivatives, followed by hydrogenation of double bonds.

4. The structure of claim 1, wherein each surface of said polymeric substrate has a substantially fixed topography comprising substructures having dimensions ranging from about 100 nanometers to about 50 microns, formed by contact with a shaped surface for imparting increased surface area, and is plasma-treated.

5. The structure of claim 1 wherein said topography is formed by imprinting or hot embossing.

6. The structure of claim 5 wherein said imprinted topography is obtained using a mold prepared using at least one of photolithography and polycarbonate membrane.

7. The structure of claim 1, wherein said at least one surface has a water contact angle no greater than 60 degrees.

8. The structure of claim 1, wherein said polymeric material provides a water contact angle of 60 degrees or greater when tested in the form of a flat untreated film or untreated film with substructures.

9. The structure of claim 1 wherein said at least one plasma-treated surface is an oxygen plasma-treated surface.

10. The structure of claim 9 wherein said at least one plasma-treated surface is a surface treated at 50 to 150 watts for 15 to 45 seconds.

11. The structure of claim 9 wherein said at least one plasma-treated surface is a surface treated at 75 to 125 watts for 25 to 35 seconds.

12. The structure of claim 9 wherein said at least one surface is plasma-treated under conditions sufficient to increase wettability to an extent sufficient to provide a water contact angle of no greater than 60 degrees without substantially altering the topography.

13. The structure of claim 1 wherein said topography comprises pillar-like substructures having an average cross-section width ranging from 100 nanometers to 50 microns, an average height ranging from 1 to 50 microns, and an aspect ratio ranging from 0.1 to 50.

14. The structure of claim 13 wherein the topography comprises pillar-like substructures having an average cross-section width ranging from 1 to 10 microns, an average height ranging from 3 to 20 microns, and an aspect ratio ranging from 1 to 20.

15. The structure of claim 1 wherein the ratio of increased surface area compared to a flat surface is at least 1.01.

16. The structure of claim 15 wherein the ratio of increased surface area compared to a flat surface is at least 1.1.

17. The structure of claim 16 wherein the pillar-like substructures are spaced apart at an average inter-structural spacing of from 100 nanometers to 100 microns.

18. The structure of claim 17 wherein the pillar-like substructures are spaced apart at an average inter-structural spacing of from 1 to 50 microns.

19. The structure of claim 1 wherein the pillar-like substructures have a protrusion density of from about 1×10⁵ to about 6×10⁸ protrusions/cm².

20. The structure of claim 19 wherein the pillar-like substructures have a protrusion density of from about 1×10⁷ to about 5×10⁷ protrusions per cm2.

21. A diagnostic test device comprising the structure of claim 1 whose surface is capable of adsorbing a biologic analyte.

22. A method for preparing a biologic adsorbent structure which comprises:
a) contacting a polymeric mass comprising a cyclic poly(olefin), a non-cyclic polyolefin, or blends thereof, with a shaped surface to form a polymeric substrate having an increased surface area on at least one surface of the polymeric substrate to provide a surface of substantially fixed topography; and
b) plasma-treating the at least one surface of substantially fixed topography to increase wettability as measured by water contact angle, without substantially altering the topography.

23. The method of claim 22, wherein said polymeric material comprises a cyclic poly(olefin).

24. The method of claim 23 wherein the polymeric substrate provides a water contact angle of 60 degrees or greater when tested in the form of a flat untreated film or untreated film with substructures.

25. The method of claim 22 wherein the cyclic poly(olefin) comprises an amorphous polyolefin having a cyclic structure polymerized by ring opening metathesis polymerization of norbornene or norbornene derivatives, followed by hydrogenation of double bonds.

26. The method of claim 22 wherein said contacting is formed by imprinting or hot embossing.

27. The method of claim 26 wherein said imprinting uses a mold prepared using at least one of photolithography and polycarbonate membrane.

28. The method of claim 22 wherein the plasma-treated surface is treated with oxygen plasma.

29. The method of claim 28 wherein the plasma-treated surface is treated at 50 to 150 watts for 15 to 45 seconds.

30. The method of claim 28 wherein the plasma-treated surface is treated at 75 to 125 watts for 25 to 35 seconds.

31. The method of claim 28 wherein the plasma-treated surface is treated under conditions sufficient to increase wettability to an extent sufficient to provide a water contact angle of no greater than 60 degrees without substantially altering the topography.

32. The method of claim 22 wherein the topography comprises pillar-like substructures having an average cross-section width ranging from 100 nanometers to 50 microns, an average height ranging from 1 to 50 microns, and an aspect ratio ranging from 0.1 to 50.

33. The method of claim 32 wherein the topography comprises pillar-like substructures having an average cross-section width ranging from 1 to 10 microns, an average height ranging from 3 to 20 microns, and an aspect ratio ranging from 1 to 20.

34. The method of claim 22 wherein the ratio of increased surface area compared to a flat surface is at least 1.01.

35. The method of claim 34 wherein the ratio of increased surface area compared to a flat surface is at least 1.1.

36. The method of claim 32 wherein the pillar-like substructures are spaced apart at an average inter-structural spacing of from 100 nanometers to 100 microns.

37. The method of claim 36 wherein the pillar-like substructures are spaced apart at an average inter-structural spacing of from 1 to 50 microns.

38. The method of claim 32 wherein the pillar-like substructures have a protrusion density of from about 1×10⁵ to about 6×10⁸ protrusions/cm².

39. The method of claim 38 wherein the pillar-like substructures have a protrusion density of from about 1×10⁷ to about 5×10⁷ protrusions per cm².

40. A method for modulating the amount of biologic uptake of a polymeric structure mass comprising a cyclic poly(olefin), a non-cyclic polyolefin, or blends thereof, the polymeric structure having a substantially fixed topography and high surface area whose biologic uptake is otherwise not a function of surface area which comprises surface treating the polymeric structure by plasma treatment to increase wettability without substantially altering the topography.

41. The method of claim 40 wherein the increase in wettability is determined by measuring a reduction in water contact angle for the treated surface compared to the untreated surface.

42. The method of claim 40 wherein the biologic is selected from at least one of sugar, lipid, protein, nucleic acid, and polynucleotide.

43. The method of claim 40 wherein the plasma treatment is oxygen plasma treatment.

44. The method of claim 43 wherein the plasma-treated surface is treated under conditions sufficient to increase wettability to an extent sufficient to provide a water contact angle of no greater than 60 degrees without substantially altering the topography.

45. The method of claim 40 wherein the plasma-treated surface is treated under conditions sufficient to increase wettability to an extent sufficient to provide a water contact angle of no greater than 60 degrees without substantially altering the topography.
